(19) United States
(12) Patent Application Publication
(10) Pub. No.: US 2016/0123053 A1
(43) Pub. Date: May 5, 2016

(54) BAGGAGE DOOR

(71) Applicant: LIPPERT COMPONENTS, INC., Elkhart, IN (US)

(72) Inventors: Dallas MARTIN, Sawyer, MI (US); David LEHMAN, Elkhart, IN (US); David WYSONG, Goshen, IN (US)

(21) Appl. No.: 14/932,402

(22) Filed: Nov. 4, 2015

Related U.S. Application Data
(60) Provisional application No. 62/074,764, filed on Nov. 4, 2014.

(51) Int. Cl. E05D 1/02; E06B 3/34; E05D 7/06; B60J 5/04

(52) U.S. Cl. CPC E05D 1/02; B60J 5/0497; E06B 3/34; E05D 7/06

(57) ABSTRACT

A door installation clip includes a mounting portion and an engagement portion. The mounting portion is configured for attachment to an exposed edge of an opening in a panel, for example, a sidewall of a vehicle. The engagement portion includes engagement members extending toward the interior of the opening. A frame having an engagement feature may be assembled to the clips and panel by inserting a portion of the frame into the opening such that the engagement feature of the frame engages with an engagement member of the clip.

### CROSS-REFERENCE TO RELATED APPLICATIONS

This application claims benefit of U.S. Provisional Patent Application No. 62/074,764, filed on Nov. 4, 2014, and incorporates by reference the disclosure thereof in its entirety.

### BACKGROUND OF THE DISCLOSURE

Baggage doors for recreational vehicles, buses, and the like typically are provided as a door panel pre-hung in a frame that may be installed in and secured to an opening in a panel, for example, a sidewall, of the vehicle. The frame typically includes a web configured to be inserted into the opening, and a flange configured to abut an outer surface of the sidewall (or a seal disposed between the flange and the sidewall) when the web is fully inserted into or through the opening. The frame may be secured to the vehicle by driving screws through the web or apertures therein and into an edge of the sidewall between the outer surface and a corresponding inner surface thereof.

### BRIEF DESCRIPTION OF THE DRAWINGS

FIG. 1 is a perspective view of a panel having an opening therein and a plurality of illustrative door installation clips according to a first embodiment of the present disclosure fastened to an edge of the opening;

FIG. 2 is a perspective view of a portion of the panel and opening therein of FIG. 1 and a plurality of door installation clips according to a first embodiment of the present disclosure fastened to an edge of the opening;

FIG. 3 is a perspective view of a portion of an illustrative door frame installed in the opening of the panel of FIG. 1 with a web of the door frame engaged with one of the door installation clips of FIG. 1;

FIG. 3A is an end view of the assembly of FIG. 3;

FIG. 4 is a side elevation view of an illustrative door installation clip according to a first embodiment of the present disclosure;

FIG. 5 is a front elevation view of the illustrative door installation clip of FIG. 4;

FIG. 6 is a rear perspective view of the door frame of FIG. 3 installed in an opening in a panel and engaged with an illustrative door installation clip according to a first embodiment of the present disclosure;

FIG. 7 is a front perspective view of a the door frame of FIG. 3 partially installed in an opening in a panel;

FIG. 8 is a front perspective view of the door frame of FIG. 3 partially installed in an opening in a panel;

FIG. 9 is a rear perspective view of a panel having an opening therein, a plurality of illustrative door clips according to a second embodiment of the disclosure attached to a surface of the panel adjacent the opening, and a door frame engaged with the door installation clips;

FIG. 10 is a rear elevation view of the panel, door frame, and door installation clips of FIG. 9;

FIG. 11 is a first cross sectional view of the panel, door frame, and one of the door installation clips of FIG. 9;

FIG. 12 is a second cross sectional view of the panel, door frame, and one of the door installation clips of FIG. 9;

FIG. 13 is a cross-sectional end view of the panel, door frame, and some of the door installation clips of FIG. 9;

FIG. 14 is a perspective view of one of the door installation clips of FIG. 9;

FIG. 15 is a side elevation view of one of the door installation clips of FIG. 9;

FIG. 16 is a cross-sectional side elevation view of one of the door installation clips of FIG. 9;

FIG. 17 is a front elevation view of one of the door installation clips of FIG. 9;

FIG. 18 is a cross-sectional side elevation view of a portion of the door frame of FIG. 9; and

FIG. 19 is a perspective view of a door installation clip according to the present disclosure with a removal tool inserted into a recess thereof.

### DETAILED DESCRIPTION OF THE DRAWINGS

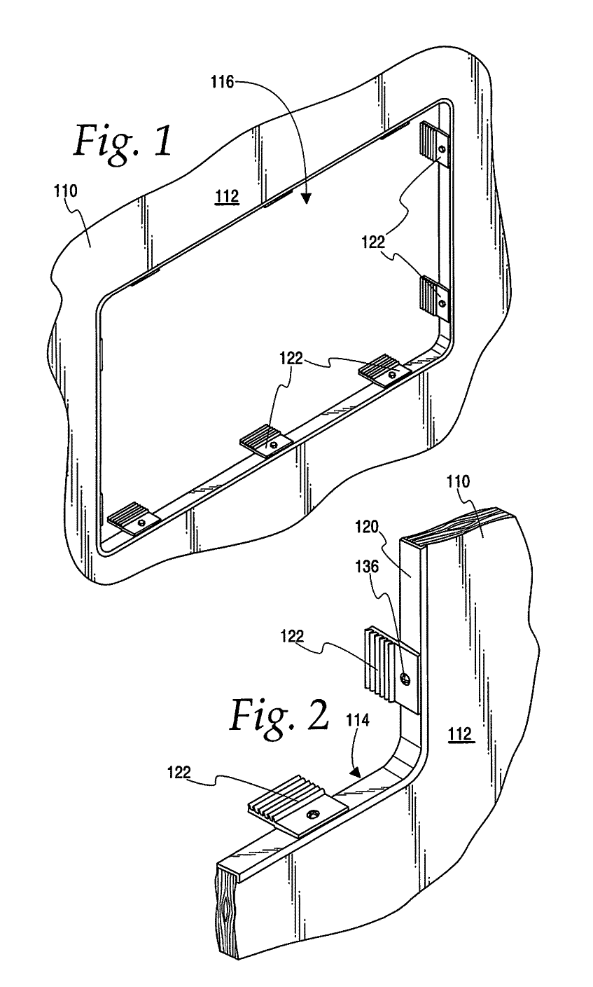

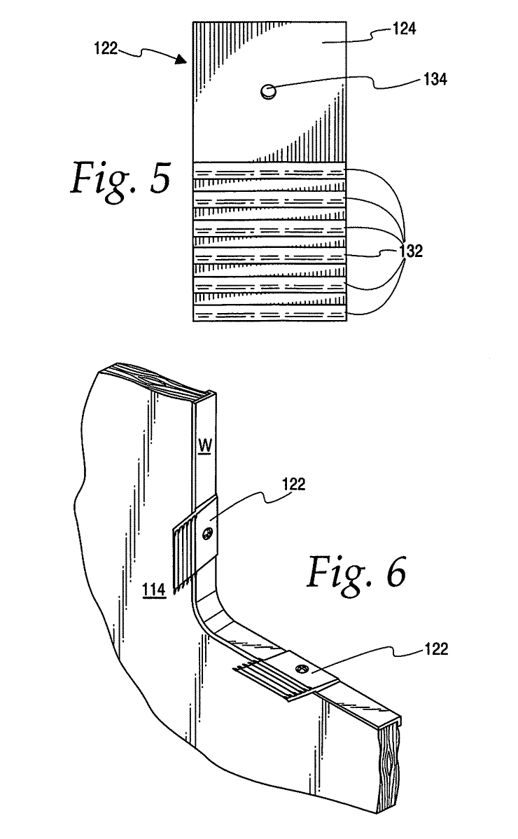

FIGS. 1-3 and 6-8 show a panel 110 that could be embodied as a side wall of a vehicle, for example, a bus or recreational vehicle. The panel 110 has a first or outer or front surface 112 and a second or inner or rear surface 114. The panel 110 defines an opening or aperture 116 extending from the first surface 112 to the second surface 114 of the panel 110. An edge 120 extends from the first surface 112 to the second surface 114 of the panel 110.

FIGS. 4 and 5 show an illustrative door installation clip 122. The door installation clip 122 includes a base portion 124 and an engagement portion 126. The base portion 124 is wedge-shaped or tapered, and it defines a mounting surface 128 and an opposite surface 130. The engagement portion 124 includes a plurality of engagement members 132 in the form of hooks or barbs extending from a surface of the engagement portion 126 corresponding to the opposite surface 130. The base portion 124 defines an aperture 134 configured to receive a screw 136 or other mechanical fastener. A land 150 extends inwardly from the mounting surface 128 proximate an interface between the base portion 124 and the engagement portion 126.

FIGS. 1-3 best show a plurality of door installation clips 122 attached to the edge 120 of the panel 110 using screws 136 inserted through the aperture 134 of the door installation clip and driven into the edge of the panel such that the engagement members face an interior of the opening 116.

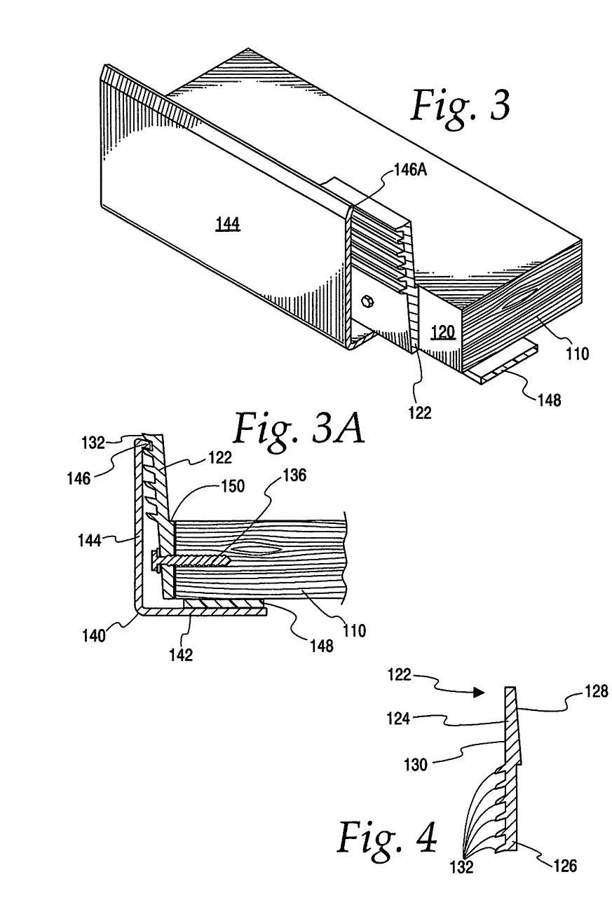

FIGS. 3-3A show in cross-section an illustrative door frame 140 inserted into the opening 116 in the panel 110 and secured to one of the door installation clips 122. The door frame 140 includes a flange 142 and web 144 extending generally perpendicularly from the flange. An engagement feature in the form of a hook 146 at the free end of the web 144 is engaged with an engagement member 132 of the door installation clip 122, as shown in FIG. 3A. Alternatively, the engagement feature could take the form of a rolled over lip or bead 146A, as shown in FIG. 3. (An engagement feature 146 in the form of a hook may provide for more secure engagement of the door frame 140 with the clip 122, whereas an engagement feature in the form of a bead or lip may allow for easier disassembly of the door frame 140 from the clip 122.) The exposed surface 30 and the corresponding surface from which the engagement members 32 of the door installation clip 124 extend taper inwardly, toward the interior of the opening 116. A gasket or seal 148 is disposed between the flange 142 and the outer surface 112 of the panel 110.

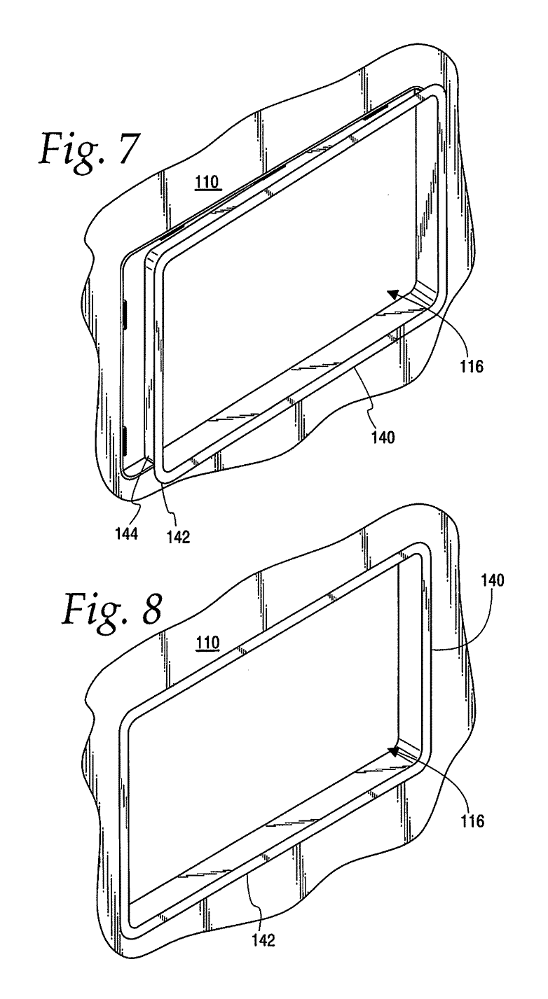

FIG. 7 shows the door frame 140 partially inserted into the opening 116 in the panel 110. FIG. 8 shows the door frame 140 fully inserted into the opening 116 in the panel 110.

Typically, a door panel (not shown) would be hingedly attached to a portion of the frame 140, for example, to the web 144 or the flange 142 of the frame 140. Alternatively, the door panel could be removably attachable to the frame 140.

The door installation clip 122 could be attached to the edge 120 of the panel 110 by placing the mounting surface 128 of the clip against the edge 120, inserting the screw 136 through the opening 134 in the clip, and driving the screw into the edge of panel. The land 150 could be used as an aid to aligning the clip 122 with the panel 110 in a desired orientation. In a typical application, a plurality of clips 122 would be installed to the edge 120.

The door frame 140 could be attached to the clips 122 by inserting the web 144 of the frame into the opening 116. As the web is inserted into the opening 116, the lip 146 engages with the engagement members 132 of the clip 122. With the clip 122 installed to the edge 120 as shown, the engagement members 132 are oriented such that the lip 146 can readily slide across the engagement members in one direction (the insertion direction), but not in the other direction (the removal direction). In some embodiments, the door frame 140 could be removed from the opening 116 by deflecting the free end of the clip 122 away from the opening, thus deflecting the engagement members 132 away from the lip 146.

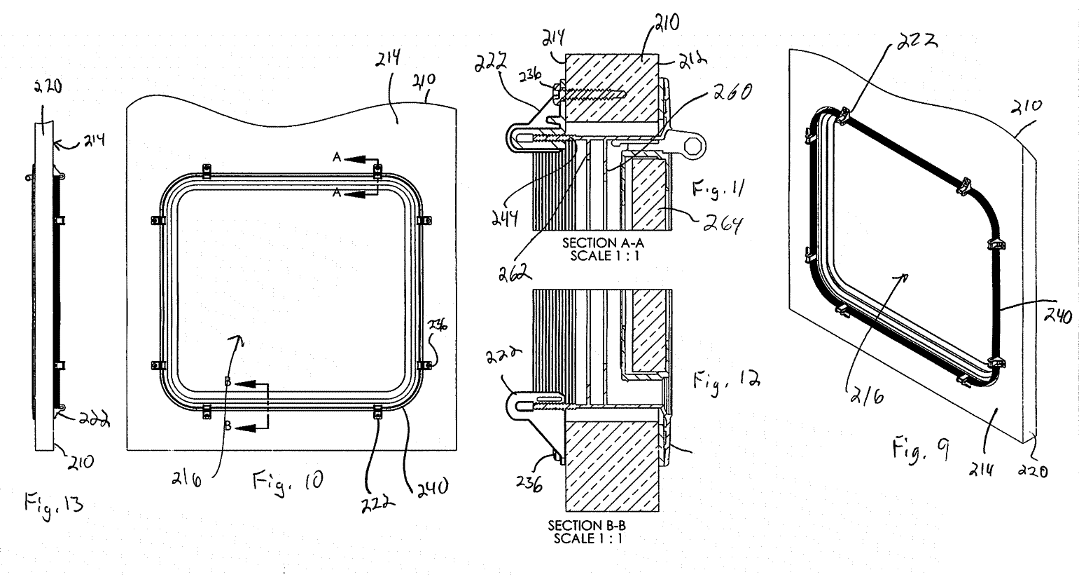

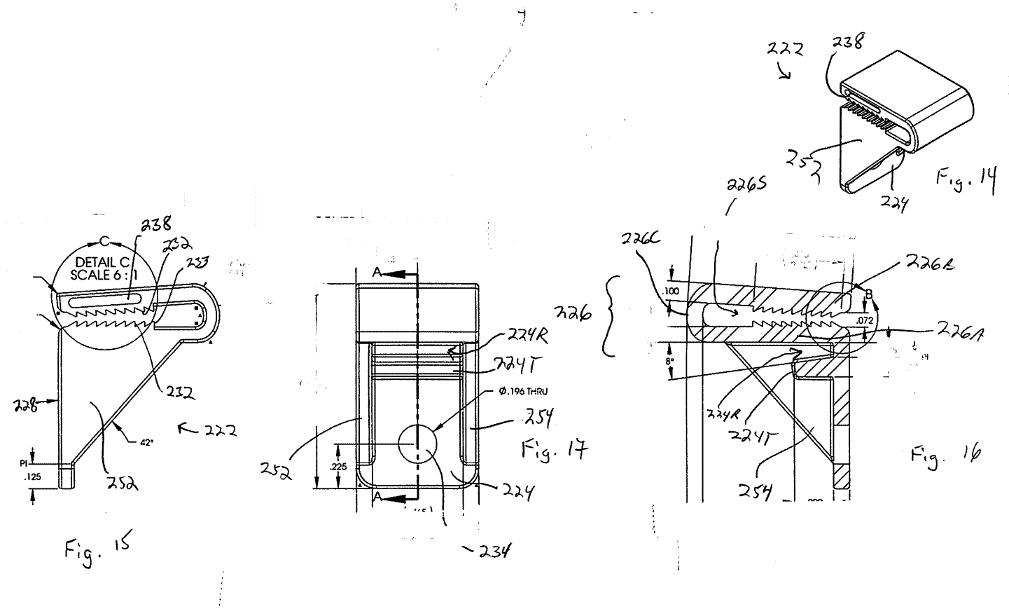

FIGS. 9-13 show another panel 210 having a first or outer or front surface 212 and a second or inner or rear surface 214. The panel 210 defines therein an opening 216 extending from the first surface 212 to the second surface 214. A plurality of illustrative door installation clips 222 is attached to the second surface 214 of the panel, and an illustrative door frame 240 is installed within the opening 216 and attached to the door installation clips.

As best shown in FIGS. 14-17, each door installation clip 222 includes a base 224 having a generally planar rear or mounting surface 228 configured for abutment with the second surface 214 of the panel 210. The base 224 defines an aperture 234 for receiving a screw 236 or other mechanical fastener that might be used to fasten the clip 222 to the panel 210. An engagement portion 226 extends generally perpendicular from the base 224 in a direction opposite the rear surface 228 of the clip 222. The engagement portion 226 of the clip 222 is generally U-shaped, having a first leg 226A extending from the base 224 and a second leg 226B generally parallel to the first leg and joined to the first leg by a connector 226C. The first leg 226A, the second leg 226B, and the connector 226C cooperate to define an interior region or slot 226S. Although the first leg 226A and the second leg 226B are generally parallel to each other, they may be out of parallel by a predetermined amount, for example, by about 4 degrees or more or less, such that the free ends of the first and second legs are closer together than the ends of the first and second legs joined to the connector 226C.

The opposing inner surfaces of each the first and second legs 226A, 226B define a plurality of engagement members 232 in the form of hooks or barbs extending inwardly from the inner surfaces of the first and second legs. The engagement members 232 are configured to cooperate with mating engagement members of a flange of the door frame 240, as will be discussed further below. The engagement members 232 are configured to allow the mating engagement members to be received therein and to secure the mating engagement members once received therein. The engagement members 232 could, but need not, extend the entire depth of the slot 226S. As shown, the engagement members 232 extend over about two-thirds of the depth of the slot 226S or somewhat more or less.

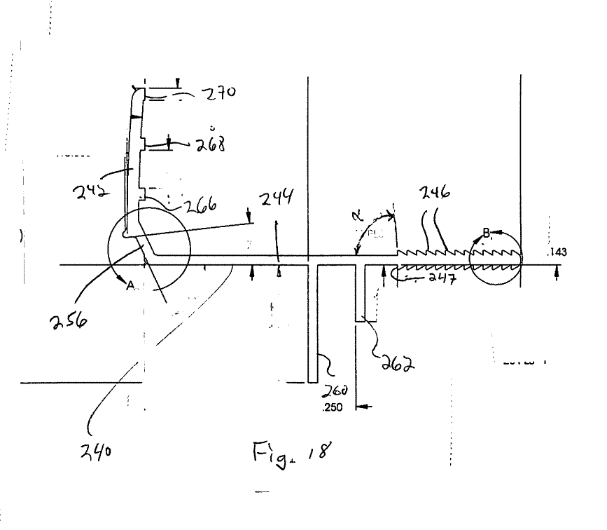

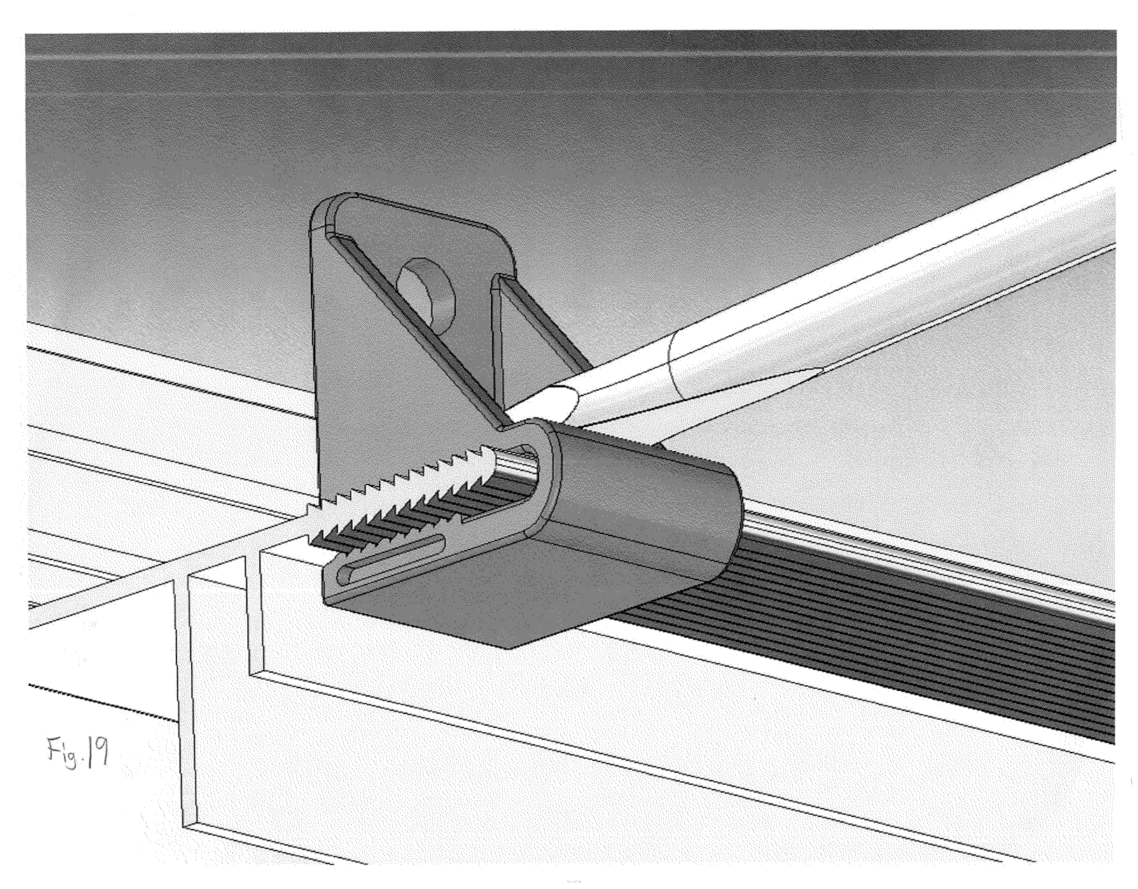

As best shown in FIGS. 16 and 17, the base 224 may include a forward-extending tab 224T that cooperates with the first leg 226A to define a recess 224R. The recess 224R may be configured to selectively receive the blade of a flat screwdriver or a similar tool, as shown in FIG. 19. As best shown in FIGS. 14 and 15, the outer edge surfaces of the second leg 226B define respective recesses or grooves 238 configured to receive the blade of a flat screwdriver or other tool (not shown). Such tools could be used to bias the first and second legs 226A, 226B of the engagement portion 26 apart from each other to enable disengagement of the engagement members 232 of the clip 22 from complementary engagement members of the door frame 240, as will be discussed further below.

A first web 252 may extend between the base 224 and the first leg 226A proximate first outer edges thereof, and a second web 254 may extend between the base and the first leg proximate second outer edges thereof opposite the first outer edges thereof. The first and second webs 252, 254 are shown as generally triangular but could have other shapes.

The door installation clip 222 may be made of any suitable material that is sufficiently flexible to allow for the first and second legs 226A, 226B to spread apart to receive the engagement members of the frame flange and sufficiently resilient to return toward their normal position to secure the frame flange thereto. In an embodiment, the clip 222 may be made of Delrin® plastic or another material having suitable flexibility and resiliency. For example, the clip 222 may be made of a suitable metal or metal-reinforced plastic.

FIG. 18 is a cross-sectional view of the door frame 240. The door frame 240 may include a first leg 242 and a second leg 244 generally perpendicular to the first leg. As shown, an optional connector 256 is disposed intermediate the first leg 242 and the second leg 244. The connector 258 is shown at about a 30 degree angle to the adjacent end of the first leg and at about a 60 degree angle to the adjacent end of the second leg 244.

The first leg is generally linear but may have a slight radius of curvature, thereby defining a convexity oriented in the direction away from which the second leg 244 extends from the first leg 242. First, second, and third projections 266, 268, 270 extend a short distance generally perpendicular from the first leg 242. Each of the first, second, and third projections 266, 268, 270 terminates in a generally planar surface configured for engagement with the first surface 212 of the panel 210 or an intervening gasket or seal 248 when the door frame 240 is installed thereto.

The second leg 244 is generally linear. A free end of the second leg 244 may define a plurality of engagement features 246 extending therefrom. The engagement features 246 are configured in a manner complementary to the engagement features 232 on the door installation clip 222. An engagement surface 247 may be at an angle α from a longitudinal axis of the second leg 244. The angle α typically would be 90 degrees or more. In an embodiment, the angle α may be 87 degrees. (Engagement surfaces 233 of the engagement features 232 of the clip 222 may be angled in a complementary manner relative to the first and second legs 226A, 226B of the engagement portion 226 of the clip 222 in order to effect secure engagement of the respective engagement features 232, 246 with each other.) First and second flanges 260, 262 may extend from the second leg 244, generally perpendicular thereto. The first flange 260 may act as a stop for a door panel 264 installed in the door frame 240. A seal (not shown) may be disposed on the outer face of the first flange 260 to provide a seal between the first flange and the door when the door is closed against the first flange. The second flange 262 may be used as an attachment point for a latch to secure the door panel 264 to the door frame 240 when the door is closed.

The door frame 240 may be attached to the panel 210 proximate the opening 216 therein by attaching a plurality of door installation clips 222 to the rear surface 214 of the panel such the slot 226S of the engagement portion 226 faces and is generally perpendicular to the opening. The free end of the second leg 244 the door frame 240 may be inserted into the slot 226S of the engagement portion 226 of each of the door installation clips 222 so that the engagement members 246 of the second leg lockingly engage with the engagement members 232 of the clips 222. An intervening gasket or seal 248 may be disposed between the panel and the door frame 240. The door frame 240 could be removed from the clips 222 by biasing the first and second legs 226A, 226B of the clips apart from each other using tools engaged with the recess 224R and the grooves 238, as discussed above, and withdrawing the second leg 244 of the door frame from the respective slots 226S of the clips.

As best shown in FIG. 11, a door 264 may be hingedly attached to a first side of the door frame 240, for example, an upper side of the door frame, as part installed in the panel. A latch (not shown) may be associated with a lower side of the door 264 and the door frame 240.

The embodiments disclose herein are illustrative and may be modified without departure from the appended claims.

1. A system for attaching a compartment door into a structure, comprising:
a clip comprising:
a mounting portion configured for abutment with the structure, the mounting portion having a planar surface defining an aperture, and
a first engagement portion having a first leg attached to and extending from the mounting portion and a second leg connected to and opposite the first leg, the first leg and the second leg cooperating to define a first slot, at least one of the first leg and the second leg defining at least one first engagement member, the at least one first engagement facing the other of the first leg and the second leg;
a door frame comprising a second engagement portion defining at least one second engagement member;
the at least one first engagement member and the at least one second engagement member configured to permit insertion of the second engagement portion into the first slot and to resist withdrawal of the second engagement portion from the first slot.

2. The system of claim 1 further comprising a door pivotally connected to the door frame.

3. The system of claim wherein the first slot is substantially perpendicular to the planar surface.

4. The system of claim 1, the clip further comprising a first web extending between the mounting portion and the first engagement portion.

5. The system of claim 4, the clip further comprising a second web extending between the mounting portion and the first engagement portion.

6. The system of claim 5, the clip further comprising a tab extending from the mounting portion and between the first web and the second web.

7. The system of claim 6, wherein the tab is spaced from the mounting portion and wherein the tab and the mounting portion cooperate to define a second slot.

8. The system of claim 1, wherein the at least one of the first leg and the second leg of the first engagement portion defines a plurality of first engagement members and the second engagement portion defines a plurality of second engagement members.

9. The system of claim 1, wherein one of the first leg and the second leg deflects away from the other of the first leg and the second leg at the time that the mounting portion is inserted into the first slot.

10. The system of claim 1, wherein at least one of the first leg and the second leg is sufficiently flexible to be deflected by an external force away from the other of the first leg and the second leg to enable withdrawal of the mounting portion from the first slot.

11. The system of claim 1, the second leg defining a first side edge and a second side edge, the first side edge defining a first groove and the side edge defining a second groove.

12. The system of claim 1 wherein the first leg is connected to the second leg by a U-shaped portion extending between an end of said first leg and an end of said second leg.

13. The system of claim 1 further comprising a structure having a wall defining an opening therein, the wall having in inner surface and an outer surface, the clip attached to the inner surface.

14. The system of claim 13, at least a portion of the door frame disposed within the aperture.

15. The system of claim 1, the door frame further comprising a peripheral flange.
